(19) United States
(12) Patent Application Publication
(10) Pub. No.: US 2013/0212517 A1
(43) Pub. Date: Aug. 15, 2013

(54) Electronic Device and Display Processing Method

(71) Applicants: Beijing Lenovo Software Ltd., (US); Lenovo (Beijing) Co., Ltd., (US)

(72) Inventor: Yongfeng Liu, Beijing (CN)

(73) Assignees: Lenovo (Beijing) Co., Ltd., Beijing (CN); Beijing Lenovo Software Ltd., Beijing (CN)

(21) Appl. No.: 13/764,023

(22) Filed: Feb. 11, 2013

(30) Foreign Application Priority Data
Feb. 13, 2012 (CN) CN 20120032001.5

(51) Int. Cl. G06F 3/0482

(52) U.S. Cl. CPC G06F 3/0482
USPC 715/777

(57) ABSTRACT

The present invention provides an electronic device and a display processing method thereof. An application page is displayed on the electronic device, and the application page includes at least a subpage and a tab for identifying the subpage. The display processing includes detecting a sliding gesture on said tab; determining whether the sliding gesture satisfies a predetermined condition; and when the sliding gesture satisfies the predetermined condition, making the subpage to be not displayed on the electronic device.

The present application claims priority to Chinese Application Number CN 201210032001.5 filed Feb. 13, 2012, the entire contents of which is incorporated herein by reference.

The present invention relates to the field of electronic device, and more particularly relates to an electronic device and a display processing method thereof.

### BACKGROUND

At present, in the various electronic devices such as a flat-plate computer or a smart cell phone, a touch screen has been widely used. An electronic device with a touch screen performs the operations by receiving the gesture input from the user. However, in some cases, the users might find it is difficult to control the electronic device precisely by the predetermined gesture input.

For example, in the context of browser with multi-tab, the page of browser may comprise a plurality of subpages, and each of the subpages has a corresponding tag to identify itself. Generally, an “X” shape controls for closing the subpage is positioned on the right of the tab. The user can only click the controls to close the subpage. However, in the case where the touch screen is small-sized, the size of the controls is also small, thus it is hard to click the controls precisely.

### SUMMARY

In view of the above circumstances, the present invention provides an electronic device and a display processing method thereof, which enables the user to close or hide a specific subpage in an application page in order to increase the operation precision and improve the user experience.

According to an embodiment of the present invention, there is provided A display processing method applied to an electronic device on which an application page is displayed, said application page comprising at least a subpage and a tab for identifying said subpage, said display processing comprises: detecting a sliding gesture on said tab; determining whether said sliding gesture satisfies a predetermined condition; and when said sliding gesture satisfies said predetermined condition, making said subpage to be not displayed on said electronic device.

Said determining whether said sliding gesture satisfies a predetermined condition may comprise: determining whether the sliding track of said sliding gesture is a track sliding in a predetermined direction with a point in said tab as a start point.

Said predetermined direction may be a direction from said tab to an edge of said electronic device closest to said tab.

Making said subpage to be not displayed on said electronic device may comprise: deleting or hiding said subpage so as to make it to be not displayed on said electronic device.

Deleting said subpage may comprise: deleting said tab for identifying said subpage.

Hiding said subpage may comprise: keeping displaying said tab for identifying said subpage.

Said application page may comprise a plurality of subpages and the tabs corresponding to each of said plurality of subpages respectively, and said tabs are used to switch the display of said plurality of subpages.

According to another embodiment of the present invention, there is provided an electronic device on which an application page is displayed, said application page comprising at least a subpage and a tab for identifying said subpage, said electronic device comprises: a detecting unit configured to detect a sliding gesture on said tab; a determining unit configured to determine whether said sliding gesture satisfies a predetermined condition; and a display processing unit configured to make said subpage to be not displayed on said electronic device when said sliding gesture satisfies said predetermined condition.

Said determining unit may be configured to determine whether the sliding track of said sliding gesture is a track sliding in a predetermined direction with a point in said tab as a start point.

Said display processing unit may be configured to delete or hide said subpage so as to make it to be not displayed on said electronic device.

Said display processing unit may be configured to delete said tab for identifying said subpage.

Said display processing unit may be configured to keep displaying said tab for identifying said subpage.

In the electronic device according to the embodiment of the invention, the specific subpage corresponding the specific tab is no longer displayed in response to detecting the user's sliding gesture on the specific tab, which enables the user to close or hide the specific subpage on the application page by the simple gesture operation, thus it is possible to increase the operation precision and improve the user experience.

### BRIEF DESCRIPTION OF THE DRAWINGS

FIG. 1 is a flowchart illustrating a display processing method according to an embodiment of the invention;

FIG. 2 is a block diagram illustrating the main configuration of an electronic device according to an embodiment of the invention;

FIG. 3A and FIG. 3B illustrate a display example on an electronic device to which the display processing method according to an embodiment of the invention is applied; and

FIG. 4A and FIG. 4B illustrate another display example on an electronic device to which the display processing method according to an embodiment of the invention is applied.

### DETAILED DESCRIPTION

The embodiments of the present invention will be described in details with reference to the accompanying drawings.

Firstly, a display processing method according to an embodiment of the invention will be described.

A display processing method according to an embodiment of the invention is applied to an electronic device. The electronic device is a smart cell phone, a flat-plate computer or the like. The electronic device comprises a touch sensing unit for sensing the user's gesture input. For example, the touch sensing unit is a capacitance touch sensing unit, a resistance touch sensing unit or the like. The electronic device further comprises a display unit. The touch sensing unit and the display unit are configured to be laminated to form a touch display unit.

The contents such as an application page contained in the electronic device can be displayed on the display unit. The application page is a page of a multi-tab browser, a page of a chatting application etc., for example. The application page comprises at least a subpage and a tab for identifying the subpage. In the case of a page of a multi-tab browser, the subpage is a window page of the browser, for example. In the case of a chatting application, the subpage is a window page for chatting with a peer, for example.

Furthermore, in the case that the application page comprises a plurality of subpages and the tabs corresponding to each of the plurality of subpages respectively, the tabs can be used to switch the display of the plurality of subpages. For example, when the display processing receives a click operation on a specific tab from the user, it is possible to determine whether the specific subpage corresponding to the specific tab is currently being displayed on the electronic device. If the specific subpage is not currently displayed, the display processing displays the specific subpage on the electronic device.

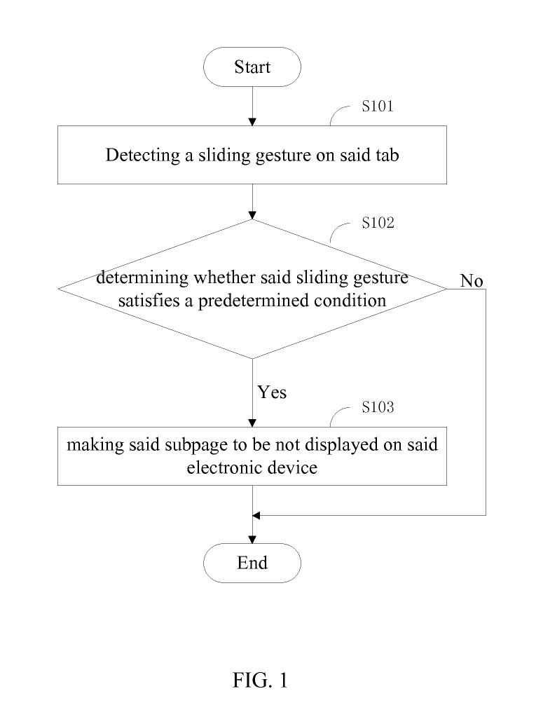

Below, the display processing method according to an embodiment of the invention will be described with reference to FIG. 1.

As shown in FIG. 1, firstly, the display processing method of the embodiment of the invention detects a sliding gesture on the tab in step S101. Specifically, the display processing method detects the sliding gesture on the tab performed by the user via an operation body (such as a finger) through the touch sensing unit.

Then, in step S102, the display processing method determines whether the sliding gesture satisfies a predetermined condition.

Specifically, in another embodiment, the display processing method determines whether the sliding distance of the sliding gesture is larger than a distance threshold. The distance threshold can be set before hand appropriately by those skilled in the art as needed.

Alternatively, in another embodiment, the display processing method determines whether the track of the sliding gesture satisfies a predetermined track. More specifically, the display processing method can determine whether the track of the sliding gesture is a track of circle, triangle or other shapes inputted into the tab, for example. In addition, the display processing method can also determine the track of the sliding gesture is a track of circle, triangle or other shapes inputted with some point in the tab as the start point.

For example, the display processing method can also determine whether the track of the sliding gesture is a track sliding in a predetermined direction with some point in the tab as the start point.

The predetermined direction can be set as an arbitrary direction by those skilled in the art as needed (particularly when where are only one subpage and the corresponding tab thereof in the application page).

Furthermore, the predetermined direction can be the direction orienting to the edge of the display unit. Thus, the user will experience making the tab disappear by the sliding gesture in direction leaving the tab, which confirms to the user's custom and improves the user experience.

Optionally, when there are a plurality of subpages and a plurality of corresponding tabs in the page and the plurality of tabs are arranged in a first direction, the direction orienting to the edge of the display unit may be a second direction (optionally, approximately perpendicular to the first direction) other than the first direction. That is to say, in this case, the display processing can change the positions of the tab and the corresponding subpage in response to receiving the sliding gesture in the first direction on the tab, and make the subpage disappear in response to receiving the sliding gesture in the second direction on the tab. Thus, the display processing method can perform different operations in response to receiving the different sliding gestures in the different directions on the tab, which confirms to the user's original custom and enriches the types of user operation.

Furthermore, optionally, the direction orienting to the edge of the display unit can be set as the direction orienting the edge closest to the tab among the edges of the display unit. Thus, the sliding distance of the sliding gesture performed by the user is short, which improves the user experience.

The predetermined condition of course is not limited to the above embodiments. Those skilled in the art can adopt any other appropriate condition as the predetermined condition. For example, the display processing can determine whether the sliding speed of the sliding gesture is larger than the speed threshold.

Next, if it is determined that the sliding gesture fails to satisfy the predetermined condition, the display processing method ends.

On the other hand, if it is determined that the sliding gesture satisfies the predetermined condition, the display processing method proceeds to step S103.

In step S103, the display processing method makes the subpage to be not displayed on the electronic device.

Specifically, the display processing method makes the subpage to be not displayed in the application page on the electronic device by deleting or hiding the subpage.

More specifically, in an embodiment, the display processing method can delete the display information relevant to the subpage from the memory unit, thus delete the subpage, which enable the user to close the subpage by the sliding gesture. In another embodiment, the display processing method can set the display state of the subpage as hidden, thus make the subpage to be not displayed on the electronic device until a command for activating display is received thereafter. Thus, the user can hide the subpage by the sliding gesture. The detailed manner by which the display processing method deletes or hides the subpage is well known for those skilled in the art, the detailed descriptions are omitted here.

In addition, the display processing method can make the tab to move along with the operation body during the operation of user's sliding gesture, thus the process of moving out of the touch screen is displayed. Furthermore, other than the sliding of the tab, the display processing method can also display the process that the corresponding subpage is sliding along with the tab. Thus, the feeling of the user will be more intuitive, which improves the user experience.

In a specific example, in the case that the display processing method deletes the subpage, the display processing method deletes the tab for identifying the subpage so that the available display space is increased.

In another specific example, in the case that the display processing method hides the subpage, the display processing method can still keep displaying the tab for identifying the subpage as so to remind the user of the existence of the subpage.

Besides, when the operation body completes the sliding input and leaves the touch screen, the display processing method can make the subpage to be not displayed through a certain kind of display effect. For example, in the case of deleting the subpage, the display processing method can display an animation to make the subpage (and the tab) fade out. Optionally, the display processing method can display an animation with the effect that it is “drawn out” or “removed” from the edge corresponding to the sliding gesture to make the subpage (and the tab) disappear. For example, in the case of hiding the subpage, the display processing method can display an animation to hide the subpage. Optionally, the display processing method can display an animation with the effect that the subpage is “drawn back” to the tab keeping on display so as to hide the subpage. The process of the animation effect is well known for those skilled in the art, the detailed descriptions are omitted here.

Note that the above-mentioned animation effects are only examples and those skilled in the art can make the subpage to be not displayed through other display effects. Thus, the user can obtain more intuitive feelings, which improves the user experience.

Thereby, the display processing method according to the embodiment of the invention is described. In the display processing method according to the embodiment of the invention, the specific subpage corresponding the specific tab is no longer displayed in response to detecting the user's sliding gesture on the specific tab. Compared with the operation that needs a precise click on the controls on the specific tab in the prior art, the display processing method according to the embodiment of the invention enable the user to close or hide the specific subpage on the application page by the simple gesture operation, thus it is possible to increase the operation precision, reduce the misoperation, and improve the user experience.

Next, the display processing method according to the embodiment of the invention will be described in combination with several specific examples.

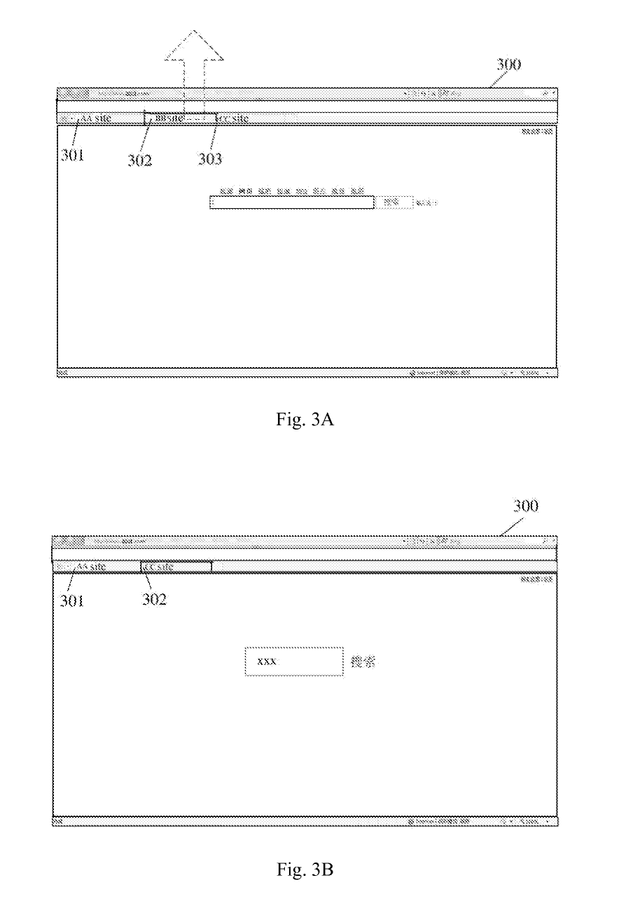

In the first specific example, the display processing method according to the embodiment of the invention is applied to a multi-tab browser application. FIG. 3A schematically illustrate an application page 300 of a multi-tab browser application displayed on the electronic device, which comprises three subpages and the respective corresponding tab 301-303. The subpage corresponding to the tab 302 is currently being displayed on the electronic device. The display processing method can switch the display of the corresponding subpage in response to the sliding gesture in the horizontal direction with the tab being the start point.

Here, the display processing method detects the sliding gesture as shown in the direction of the arrow, and determines whether the track of the sliding gesture is the track of the sliding orienting to the screen edge closest to the tab with an arbitrary point in the tab as the start point. In the case of the sliding direction in the figure, the display processing method determines that the sliding gesture satisfies the predetermined condition and deletes the subpage as so to make it to be not displayed on the electronic device, for example. The schematic view after deleting the subpage is as shown in FIG. 3B, for example. Compared with FIG. 3A, the display processing method deletes the tab 302 and the corresponding subpage thereof. That is to say, the user obtains the effect of closing the subpage corresponding to the tab 302 through the above-mentioned sliding gesture. Compared with the method wherein the user should click precisely on the specific controls in the tab 302 so as to close the subpage corresponding to the tab 302 in the prior art, the display processing method according to the embodiment of the invention facilitates the user operation and improves the user's operation precision. In the second specific example, the display processing method according to the embodiment of the invention is applied to a chatting application. In order to simplify the description, only the “current session list” portion in the chatting application is shown, and the other portions are omitted. The application interface 400 comprises three subpages and the respective corresponding tab 401-403. The subpage 404 corresponding to the tab 401 is currently being displayed on the electronic device.

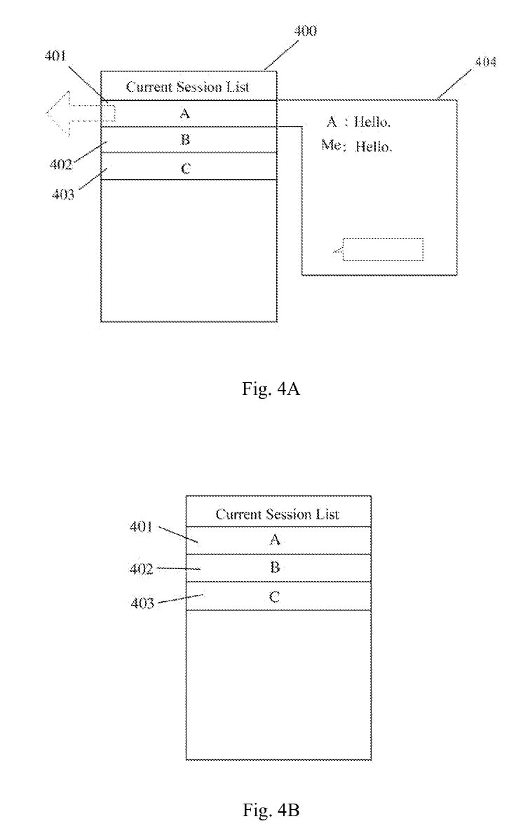

Here, the display processing method detects the sliding gesture as shown in the direction of the arrow, and determines that whether the sliding distance of the sliding gesture is beyond the predetermined condition. In the case as show in the figure, it is assumed that the display processing method determines the sliding gesture satisfies the predetermined condition, and hides the subpage so as to make it to be not displayed on the electronic device. The schematic view after hiding the subpage is as shown in FIG. 4B, for example. Compared with FIG. 4A, the display processing method hides the subpage 404, and keeps displaying the corresponding tab 401 thereof. That is to say, the user obtains the effect of hiding the subpage 404 corresponding to the tab 401 through the above-mentioned sliding gesture. Compared with the prior art, the display processing method according to the embodiment of the invention facilitates the user operation, improves the user's operation precision, confirms to the user's operation custom and improves the user experience.

Furthermore, taking the application page and the subpages thereof displayed on the electronic device as an example, the display processing method according to the embodiment of the invention has been described. Those skilled in the art will appreciate that the display processing method is not limited to the above examples. For example, the display processing method according to the embodiment of the invention can also be applied to the case of the main page of the operation system and the pages of the application operating in the operation system displayed on the electronic device.

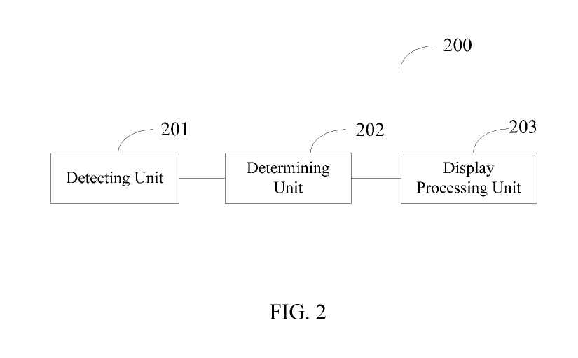

Next, the display processing device according to the embodiment of the invention will be described with reference to FIG. 2. The display processing device according to the embodiment of the invention is embodied in the form of electronic device. The electronic device is a smart cell phone, a flat-plate computer or the like. An application page is displayed on the electronic page, and the application page comprises at least one subpage and the tab for identifying the subpage.

As shown in FIG. 2, the electronic device 200 according to the embodiment of the invention comprises: a detecting unit 201, a determining unit 202 and a display processing unit 203.

Specifically, the detecting unit 201 is configured to detect a sliding gesture on the tab, which can be configured by a touch sensing unit. The determining unit 202 is configured to determine whether the sliding gesture satisfies a predetermined condition. The display processing unit 203 is configured to make the subpage to be not displayed on the electronic device when the sliding gesture satisfies the predetermined condition.

More specifically, in an embodiment, the determining unit 202 is configured to determine whether the sliding track of the sliding gesture is the track orienting to a predetermined direction with a point in the tab as the start point.

Alternatively, in another embodiment, the determining unit 202 is configured to determine whether the sliding distance is larger than a distance threshold. The distance threshold can be set before hand appropriately by those skilled in the art as needed.

Of course, the predetermined condition is not limited to the above embodiments. Those skilled in the art can adopt any other appropriate condition as the predetermined condition. For example, the determining unit 202 can be configured to determine whether the sliding speed of the sliding gesture is larger than the speed threshold.

The display processing unit 203 is configured to delete or hide the subpage so as to make it to be not displayed on the electronic device.

More specifically, in the case of deleting the subpage, the display processing unit 203 is further configured to delete the tab for identifying the subpage so that the available display space is increased.

In the case of hiding the subpage, the display processing unit 203 is further configured to keep displaying the tab for identifying the subpage as so to remind the user of the existence of the subpage.

Thereby, the electronic device according to the embodiment of the invention is described. In the electronic device according to the embodiment of the invention, the specific subpage corresponding the specific tab is no longer displayed in response to detecting the user's sliding gesture on the specific tab. Compared with the operation that needs a precise click on the controls on the specific tab in the prior art, the electronic device according to the embodiment of the invention enable the user to close or hide the specific subpage on the application page by the simple gesture operation, thus it is possible to increase the operation precision, reduce the misoperation, and improve the user experience.

Hereinbefore, the electronic device and the display processing method thereof have been described with reference to FIG. 1 to FIG. 4.

It should be noted that, in this specification, the terms “comprising”, “including” or any other variant are intended to cover a non-exclusive inclusion, so that the process, method, article or device comprising a series of elements comprises not only those elements, but also comprises other elements not expressly listed, or further comprises elements inherent in this process, method, article, or device. In the case of no more restrictions, the elements defined by the statement “comprises a . . . ”, do not preclude the existence of additional identical elements in the process, method, article or device comprising the elements.

Finally, it should be noted that, the above-described series of processes comprise not only the processes performed in time series in the order described herein, but also comprise the processes performed concurrently or separately, instead of in chronological order.

Through the above description of the embodiments, the skilled in the art can clearly understand that the present invention can be implemented by means of software plus a necessary hardware platform; certainly, it can also be implemented entirely by hardware. Based on such understanding, all or part of the contribution of the technical solution of the present invention to the background art, may be embodied in the form of a software product, which can be stored in a storage medium, such as a ROM/RAM, hard disk, optical disk, etc., comprising a plurality of instructions for allowing a computer device (which may be a personal computer, a server, or a network device, etc.) to perform the methods described in various embodiments or in some portion of the embodiments of the present invention.

The above has described the present invention in detail, and specific examples are used herein to explain the principles and embodiments of the invention. However, the above description of the embodiments is only used to help understanding the methods and core ideas of the present invention; meanwhile, for the ordinary skilled in the art, based on the ideas of the invention, variations can be made both in implementations and application ranges; in summary, the content of this specification should not be understood as limitative to the present invention.

What is claimed is:

1. A display processing method applied to an electronic device on which an application page is displayed, said application page comprising at least a subpage and a tab for identifying said subpage, said display processing comprises:
detecting a sliding gesture on said tab;
determining whether said sliding gesture satisfies a predetermined condition; and
when said sliding gesture satisfies said predetermined condition, making said subpage to be not displayed on said electronic device.

2. The display processing method according to claim 1, wherein said determining whether said sliding gesture satisfies a predetermined condition comprises determining whether the sliding track of said sliding gesture is a track sliding in a predetermined direction with a point in said tab as a start point.

3. The display processing method according to claim 2, wherein said predetermined direction is a direction from said tab to an edge of said electronic device closest to said tab.

4. The display processing method according to claim 1, wherein making said subpage to be not displayed on said electronic device comprises deleting or hiding said subpage so as to make it to be not displayed on said electronic device.

5. The display processing method according to claim 4, wherein deleting said subpage further comprises deleting said tab for identifying said subpage.

6. The display processing method according to claim 4, wherein hiding said subpage further comprises keeping displaying said tab for identifying said subpage.

7. The display processing method according to claim 1, wherein said application page comprises a plurality of subpages and the tabs corresponding to each of said plurality of subpages respectively, and said tabs are used to switch the display of said plurality of subpages.

8. An electronic device on which an application page is displayed, said application page comprising at least a subpage and a tab for identifying said subpage, said electronic device comprises:
a detecting unit configured to detect a sliding gesture on said tab;
a determining unit configured to determine whether said sliding gesture satisfies a predetermined condition; and
a display processing unit configured to make said subpage to be not displayed on said electronic device when said sliding gesture satisfies said predetermined condition.

9. The electronic device according to claim 8, wherein said determining unit is configured to determine whether the sliding track of said sliding gesture is a track sliding in a predetermined direction with a point in said tab as a start point.

10. The electronic device according to claim 8, wherein said display processing unit is configured to delete or hide said subpage so as to make it to be not displayed on said electronic device.

11. The electronic device according to claim 10, wherein said display processing unit is configured to delete said tab for identifying said subpage.

12. The electronic device according to claim 10, wherein said display processing unit is configured to keep displaying said tab for identifying said subpage.
